(19) United States
(12) Patent Application Publication
(10) Pub. No.: US 2026/0177205 A1
(43) Pub. Date: Jun. 25, 2026

(54) SYSTEMS AND METHODS FOR FILLING A PLURALITY OF STORAGE DEVICES

(71) Applicant: CNX Resources Corporation, Canonsburg, PA (US)

(72) Inventors: Kevin Robert Egeland, Pittsburgh, PA (US); Joseph Michael Fink, Washington, PA (US)

(21) Appl. No.: 18/990,587

(22) Filed: Dec. 20, 2024

(51) Int. Cl. F17C 5/06; F17C 13/04

(52) U.S. Cl. CPC F17C 5/06; F17C 13/04; F17C 2227/0337; F17C 2227/04; F17C 2250/043; F17C 2250/0439; F17C 2250/0491; F17C 2250/0636

(57) ABSTRACT

A system includes a plurality of storage devices operable to receive compressible fluid from a source and a flow line network extending between and fluidly connecting the plurality of storage devices and the source. The system further includes a plurality of stoppage valves and a plurality of flow control valves in fluid communication with the flow line network and a plurality of chillers in thermal communication with the flow line network. The plurality of stoppage valves fluidly connects the plurality of storage devices in a series arranged sequentially from a highest-pressure storage device to a lowest-pressure storage device, fluidly disconnects storage devices from the series, and fluidly connects additional storage devices to the series. The plurality of flow control valves controls a flow rate of compressible fluid received by each storage device. The plurality of chillers decreases a temperature of the compressible fluid received by each storage device.

### TECHNICAL FIELD

The present disclosure relates to systems and methods for filling compressible fluid storage devices. More particularly, the present disclosure relates to systems and methods to prevent undesirable temperatures within compressible fluid storage devices during filling operations of the compressible fluid storage devices.

### BACKGROUND

A common process for the distribution of compressible fluids, such as compressed natural gas (CNG), may include dispensing a compressible fluid from a high-pressure source into a compressible fluid storage device, transporting the compressible fluid storage device to a destination, delivering the compressible fluid within the compressible fluid storage device to a low-pressure demand at the destination, and transporting the depleted compressible fluid storage device back to the high-pressure source to restart the process.

During a compressible fluid filling operation (e.g., dispensing the compressible fluid from the high-pressure source into a compressible fluid storage device), a compressible fluid storage device may experience a significant temperature increase. Specifically, as fluid is received by the compressible fluid storage device, the pressure within the compressible fluid storage device increases. Accordingly, the temperature of the fluid within the compressible fluid storage device increases as the pressure within the compressible fluid storage device increases.

The temperature change within compressible fluid storage devices may have various detrimental effects during a compressible fluid filling operation. Temperature increases within a compressible fluid storage device routinely delay a filling operation of the compressible fluid storage device to an acceptable fluid density. When the temperature of the fluid in the compressible fluid storage device approaches a maximum operating temperature of the compressible fluid storage device (as defined by the compressible fluid storage device manufacturer, e.g. 180° F. for a CNG storage device) or the pressure of the compressible fluid storage device approaches the pressure of the high-pressure source or the maximum operating pressure of the compressible fluid storage device (as defined by the compressible fluid storage device manufacturer, e.g. 4,500 psig for a CNG storage device) while the density of the compressible fluid in the tank is still undesirably low, the filling operation must be temporarily halted to allow the fluid within the compressible fluid storage device to cool down (e.g., by heat transfer with ambient air through the wall of the compressible fluid storage device).

A cooling device may be employed to cool the fluid being delivered to the compressible fluid storage device in order to reduce the rate of internal energy accumulation within the compressible fluid storage device during a filling operation. However, the temperature to which the delivered fluid must be cooled for a compressible fluid storage device to become nominally full may be undesirably low (e.g., −10° F. or lower). In addition, the costs associated with a cooling device operable to reduce the temperature of the delivered fluid to such a temperature may be undesirable. Furthermore, the amount of power required to be consumed by the cooling device in order to cool the delivered fluid to such a temperature may also be undesirable.

### SUMMARY

In a first embodiment, the present disclosure describes a system including a plurality of storage devices operable to receive compressible fluid from a high-pressure source and a flow line network extending between and fluidly connecting the plurality of storage devices and the high-pressure source. The system further includes a plurality of stoppage valves and a plurality of flow control valves in fluid communication with the flow line network and a plurality of chillers in thermal communication with the flow line network. The plurality of stoppage valves is operable to fluidly connect the plurality of storage devices in a series arranged sequentially from a highest-pressure storage device of the plurality of storage devices to a lowest-pressure storage device of the plurality of storage devices, fluidly disconnect one or more storage devices from the series, and fluidly connect one or more additional storage devices to the series. The plurality of flow control valves is operable to control a flow rate of a portion of compressible fluid received by each storage device. The plurality of chillers is operable to decrease a temperature of the portion of compressible fluid received by each storage device.

In one aspect of the first embodiment, the system further includes a plurality of sensors operable to measure one or more characteristics of the portion of compressible fluid within each storage device.

In another aspect of the first embodiment, which may be combined with one or more previously recited aspects of the first embodiment, one or more stoppage valves of the plurality of stoppage valves are operable to actuate in response to the one or more characteristics of the portion of compressible fluid within one or more storage devices meeting a threshold.

In another aspect of the first embodiment, which may be combined with one or more previously recited aspects of the first embodiment, the one or more characteristics of the portion of compressible fluid within each storage device includes one or more of the temperature of the portion of compressible fluid or a pressure of the portion of compressible fluid.

In another aspect of the first embodiment, which may be combined with one or more previously recited aspects of the first embodiment, each storage device is a storage tank array including a plurality of storage tanks fluidly connected in parallel between a first manifold and a second manifold. The first manifold is operable to deliver compressible fluid from the flow line network to each storage tank of the plurality of storage tanks simultaneously, and the second manifold is operable to deliver a portion of compressible fluid from each storage tank of the plurality of storage tanks to the flow line network simultaneously.

In another aspect of the first embodiment, which may be combined with one or more previously recited aspects of the first embodiment, each storage tank of the plurality of storage tanks includes an inlet in fluid communication with the first manifold and disposed at a first end of the storage tank and an outlet in fluid communication with the second manifold and disposed at a second end of the storage tank.

In another aspect of the first embodiment, which may be combined with one or more previously recited aspects of the first embodiment, each storage tank of the plurality of storage tanks includes an inlet in fluid communication with the first manifold and an outlet in fluid communication with the second manifold. The inlet and the outlet are disposed at a first end of the storage tank. Each storage tank further includes a conduit extending, within an interior of the storage tank, from the inlet or the outlet towards a second end of the storage tank.

In another aspect of the first embodiment, which may be combined with one or more previously recited aspects of the first embodiment, the portions of compressible fluid being received by each storage device are transported downstream in the series by pressure differentials between sequentially adjacent storage devices of the series.

In another aspect of the first embodiment, which may be combined with one or more previously recited aspects of the first embodiment, the flow rate of the portion of compressible fluid being received by each storage device decreases after each storage device in the series by the plurality of flow control valves.

In another aspect of the first embodiment, which may be combined with one or more previously recited aspects of the first embodiment, each storage device is operable to couple with a vehicle configured to transport the storage device.

In another aspect of the first embodiment, which may be combined with one or more previously recited aspects of the first embodiment, the system further includes a plurality of bays in fluid communication with the flow line network. Each bay includes an inlet line operable to fluidly connect an inlet of a storage device to the flow line network and an outlet line operable to fluidly connect an outlet of the storage device to the flow line network.

In a second embodiment, the present disclosure describes a method that includes actuating one or more stoppage valves of a plurality of stoppage valves in fluid communication with a flow line network extending between a plurality of storage devices and a high-pressure source to fluidly connect the plurality of storage devices in a series arranged sequentially from a highest-pressure storage device of the plurality of storage devices to a lowest-pressure storage device of the plurality of storage devices. The method further includes receiving, by each storage device of the plurality of storage devices, a portion of compressible fluid from upstream in the flow line network, such that the portion of compressible fluid received by the highest-pressure storage device is transported from the high-pressure source and the portion of compressible fluid received by the lowest-pressure storage device is transported from a sequentially upstream storage device in the series. In addition, the method includes controlling, by a plurality of flow control valves in fluid communication with the flow line network, a flow rate of the portion of compressible fluid being received by each storage device, and decreasing, by a plurality of chillers in thermal communication with the flow line network, a temperature of the portion of compressible fluid being received by each storage device. Further, the method includes actuating one or more stoppage valves to fluidly disconnect the highest-pressure storage device from the series and actuating one or more stoppage valves to fluidly connect an additional storage device to the series. Upon fluidly disconnecting the highest-pressure storage device from the series, a storage device previously sequentially downstream of the disconnected highest-pressure storage device becomes the highest-pressure storage device. The additional storage device includes a pressure less than the lowest-pressure storage device such that when the additional storage device is fluidly connected to the series, the additional storage device becomes the lowest-pressure storage device.

In one aspect of the second embodiment, the method further includes measuring one or more characteristics of the portion of compressible fluid within each storage device with one or more sensors.

In another aspect of the second embodiment, which may be combined with one or more previously recited aspects of the second embodiment, the actuation the one or more stoppage valves of the plurality of stoppage valves is based on the one or more characteristics of the portion of compressible fluid within one or more storage devices meeting a threshold.

In another aspect of the second embodiment, which may be combined with one or more previously recited aspects of the second embodiment, the one or more characteristics of the portion of compressible fluid within each storage device includes one or more of the temperature of the portion of compressible fluid or a pressure of the portion of compressible fluid.

In another aspect of the second embodiment, which may be combined with one or more previously recited aspects of the second embodiment, each storage device is a storage tank array including a plurality of storage tanks fluidly connected in parallel between a first manifold and a second manifold. The method further includes delivering, through the first manifold, compressible fluid from the flow line network to each storage tank of the plurality of storage tanks simultaneously, and delivering, through the second manifold, a portion of compressible fluid from each storage tank of the plurality of storage tanks to the flow line network simultaneously.

In another aspect of the second embodiment, which may be combined with one or more previously recited aspects of the second embodiment, the method further includes transporting the portions of compressible fluid downstream in the series by pressure differentials between sequentially adjacent storage devices of the series.

In another aspect of the second embodiment, which may be combined with one or more previously recited aspects of the second embodiment, controlling the flow rate of the portion of compressible fluid being received by each storage device includes decreasing the flow rate after each storage device in the series by the plurality of flow control valves.

In another aspect of the second embodiment, which may be combined with one or more previously recited aspects of the second embodiment, each storage device in the series is fluidly connected to a bay of a plurality of bays in fluid communication with the flow line network. Each bay includes an inlet line and an outline line. The method further includes fluidly connecting an inlet of a storage device to the flow line network by the inlet line, and fluidly connecting an outlet of the storage device to the flow line network by the outlet line.

In another aspect of the second embodiment, which may be combined with one or more previously recited aspects of the second embodiment, the method further includes transporting the disconnected highest-pressure storage device to another location away from the flow line network and transporting the additional storage device to an empty bay of the plurality of bays. The plurality of bays includes one or more empty bays.

These and other features and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of any of the aspects disclosed herein.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The systems and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 is a schematic diagram illustrating a system according to one or more embodiments of the present disclosure.

FIG. 2 is a schematic diagram illustrating a storage device according to one or more embodiments of the present disclosure.

FIG. 3 is a schematic diagram illustrating a storage device according to one or more embodiments of the present disclosure.

FIG. 4 is a schematic diagram illustrating a storage device according to one or more embodiments of the present disclosure.

FIGS. 5A-5B show an operational sequence of a filling operation employing a system according to one or more embodiments of the present disclosure.

FIG. 6 is a graph depicting example gas densities within storage devices during a first filling operation and a second filling operation according to one or more embodiments of the present disclosure.

FIG. 7 is a graph depicting example pressures within storage devices during a first filling operation and a second filling operation according to one or more embodiments of the present disclosure.

FIG. 8 is a graph depicting example temperatures within storage devices during a first filling operation and a second filling operation according to one or more embodiments of the present disclosure.

FIG. 9 is a graph depicting example total chilling duties of systems during a first filling operation and a second filling operation according to one or more embodiments of the present disclosure.

FIG. 10 is a graph depicting example outlet temperatures of cooling devices of a system during a first filling operation and a second filling operation according to one or more embodiments of the present disclosure.

FIG. 11 is a schematic diagram illustrating a system according to one or more embodiments of the present disclosure.

FIG. 12 is a schematic diagram illustrating a system according to one or more embodiments of the present disclosure.

FIG. 13 is flowchart of a method according to one or more embodiments of the present disclosure.

### DESCRIPTION

Numerous specific details are set forth to provide a thorough understanding of the overall structure, function, manufacture, and use of the aspects as described in the disclosure and illustrated in the accompanying drawings. Well-known operations, components, and elements have not been described in detail so as not to obscure the aspects described in the specification. The reader will understand that the aspects described and illustrated herein are non-limiting examples, and thus it can be appreciated that the specific structural and functional details disclosed herein may be representative and illustrative. Variations and changes thereto may be made without departing from the scope of the claims.

In the following description, it is to be understood that such terms as “forward,” “rearward,” “left,” “right,” “above,” “below,” “upward,” “downward,” and the like are words of convenience and are not to be construed as limiting terms.

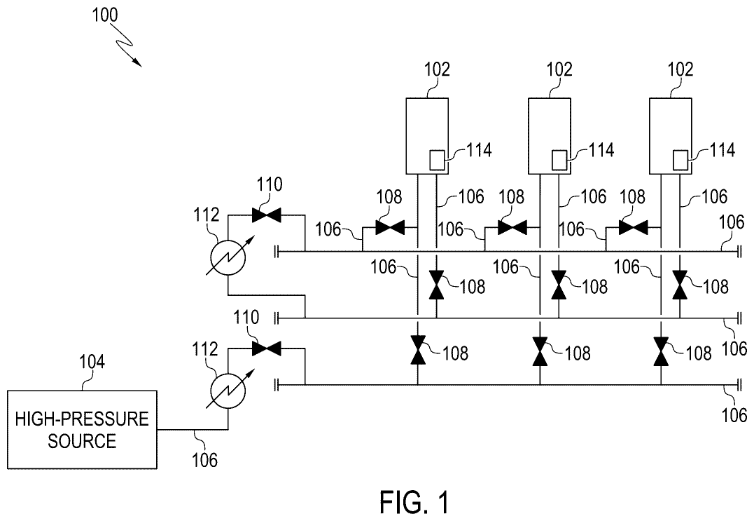

FIG. 1 depicts a schematic diagram of a system 100 according to one or more embodiments of the present disclosure. The system 100 includes a plurality of storage devices 102 operable to receive and store a compressible fluid from a high-pressure source 104. Each storage device 102 may be a sealed rigid container(s), a stationary tank, a mobile trailer, or an equivalent device known to those of ordinary skill in the art. In one or more embodiments, the plurality of storage devices 102 may be disposed upon and transported by a single mobile unit. In one or more embodiments, the compressible fluid may be a compressed natural gas, which the industry defines as CNG.

In one or more embodiments, the high-pressure source 104 may be embodied as a wellhead producing natural gas from a high-pressure reservoir. In one or more embodiments, the natural gas of the high-pressure source 104 may be removed of any solids and liquids as well as dried to a substantially low water vapor content (e.g., 10 ppmv). In one or more embodiments, the high-pressure source 104 may be the discharge of a compressor that is designed to compress a fluid to suitably high pressures. In one or more embodiments, the high-pressure source 104 may be embodied as an underground storage field or a stationary high-pressure storage device that is operable to be continually replenished by the discharge of a compressor or a wellhead producing natural gas from a high-pressure reservoir.

The system 100 further includes a network of flow lines, or a flow line network, extending between and fluidly connecting the plurality of storage devices 102 to the high-pressure source 104. The flow line network may be formed of a plurality of flow lines 106 operable to transport compressible fluid from the high-pressure source 104 to the plurality of storage devices 102. As such, one or more flow lines 106 of the plurality of flow lines 106 may be fluidly connected to each storage device 102 of the plurality of storage devices 102, and one or more flow lines 106 of the plurality of flow lines 106 may be fluidly connected to the high-pressure source 104. The plurality of flow lines 106 may be formed of as piping, hosing, or an equivalent form of conduit. In addition, the plurality of flow lines 106 may be formed of a polymer, metal, or an equivalent material known to those of ordinary skill in the art which is designed to withstand the temperatures and pressures associated with a filling operation of compressible fluid storage devices.

The system 100 further includes a plurality of stoppage valves 108 in fluid communication with the flow line network. Each stoppage valve 108 of the plurality of stoppage valves 108 is operable to control a flow of the compressible fluid by actuation between a closed configuration and an open configuration. That is, when a stoppage valve 108 is in a closed configuration, the stoppage valve 108 prevents fluid from passing through the stoppage valve 108. Further, when a stoppage valve 108 is in an open configuration, the stoppage valve 108 permits fluid to pass through the stoppage valve 108. In this way, the plurality of stoppage valves 108 is operable to control a flow path of the compressible fluid through the system 100.

In one or more embodiments, the plurality of stoppage valves 108 is operable to create a flow path in the system 100 such that two or more storage devices 102 of the plurality of storage devices 102 are arranged in a series. That is, one or more stoppage valves 108 may be actuated to the open configuration and one or more stoppage valves 108 may be actuated to the closed configuration in order to create a flow path that fluidly connects two or more storage devices 102 in a series. Further, one or more stoppage valves 108 may be actuated such that the high-pressure source 104 is fluidly connected to the upstream end of the series.

In one or more embodiments, the series is arranged based at least in part on a characteristic of the compressible fluid within each storage device 102 of the series. For example, the series may be arranged sequentially from a highest-pressure storage device of the plurality of storage devices 102 to a lowest-pressure storage device of the plurality of storage devices 102. In this way, the pressure differentials of the storage devices 102 may drive the fluid through the system 100. As such, in one or more embodiments, external power need not be applied to the system 100 to transport the fluid through the system 100. That is, in one or more embodiments, fluid may flow through the system 100 without the use of pumps, compressors, or any similar device that consumes power. As such, in one or more embodiments, the pressure of the high-pressure source 104 is greater than the pressure of the storage device in direct communication with the high-pressure source 104.

The system 100 further includes a plurality of flow control valves 110 in fluid communication with the flow line network. Each flow control valve 110 of the plurality of flow control valves 110 is operable to control a flow rate of the fluid passing through the flow control valve 110. Each flow control valve 110 of the plurality of flow control valves 110 may have different target flow rates. In one or more embodiments, the flow rates of the flow control valves 110 may be dynamically modulated. As such, in one or more embodiments, two or more flow control valves 110 of the plurality of flow control valves 110 may include a same flow rate during at least part of a filling operation.

Alternatively, in one or more embodiments, one or more stoppage valves 108 may be further operable to control the flow rate of fluid passing through the one or more stoppage valves 108. For instance, the one or more stoppage valves 108 may be positioned in one or more intermediate positions between an open configuration and a closed configuration in order to control the flow rate of the fluid passing through the one or more stoppage valves 108.

In one or more embodiments, the plurality of stoppage valves 108 and the plurality of flow control valves 110 may be any type of valve suitable for flow control and flow rate control, respectively, at pressures up to, for example, 5,000 psi. In one or more embodiments, the plurality of stoppage valves 108 and the plurality of flow control valves 110 may be selectively operated in a manual operation mode. That is, a stoppage valve 108 or a flow control valve 110 may be selectively and manually positioned by rotating a handle of the valve, pressing buttons on the valve, etc. In one or more embodiments, each stoppage valve 108 and each flow control valve 110 includes an electrical, hydraulic, or pneumatic actuator, such that the positioning of the plurality of stoppage valves 108 and the plurality of flow control valves 110 may be performed automatically in response to a signal received from a control circuit of the system 100. The actuators of the plurality of stoppage valves 108 and the plurality of flow control valves 110 may be fast-acting and operable to rapidly transition a valve between a closed configuration and an open configuration, as well as the one or more intermediate positions between the closed configuration and the open configuration.

The system 100 further includes a plurality of chillers 112 in fluid communication with the flow line network. Each chiller 112 of the plurality of chillers 112 is operable to control a temperature of the fluid passing through the chiller 112. The plurality of chillers 112 may be forms of heat exchangers or other devices suitable for controlling a temperature of a fluid stream. In one or more embodiments, each chiller 112 of the plurality of chillers 112 includes a same output temperature. Alternatively, each chiller 112 of the plurality of chillers 112 may be controlled to include a different output temperature.

In one or more embodiments, one or more chillers 112 of the plurality of chillers 112 are disposed upstream of each storage device 102 in the series. In this way, the plurality of chillers 112 is operable to control the temperature of the fluid entering each storage device 102. Similarly, in one or more embodiments, one or more flow control valves 110 are disposed upstream of each storage device 102 in the series. Accordingly, the plurality of flow control valves 110 is operable to control the flow rates of the fluid entering each storage device 102. In the non-limiting example of FIG. 1, a flow control valve 110 is disposed downstream of each chiller 112. However, in one or more embodiments, a flow control valve 110 may be disposed upstream of each chiller 112.

In one or more embodiments, one or more sensors 114 may be coupled to each storage device 102 that measure and monitor one or more characteristics of the compressible fluid within the storage device 102 (e.g., temperature, pressure, density, etc.). In one or more embodiments, one or more sensors 114 may be coupled to a flow line 106 downstream or upstream of each storage device 102 to measure and monitor one or more characteristics of the fluid exiting or entering the storage device 102, respectively. The one or more sensors 114 may be operable to determine whether the one or more characteristics are above or below predetermined thresholds. Accordingly, the one or more sensors 114 may trigger an audible or visual alert notifying an operator of the system 100 that one or more characteristics of the compressible fluid within, exiting, or entering a storage device 102 have met a predetermined threshold. For example, as fluid is delivered from the high-pressure source 104 to the highest-pressure storage device, the pressure within the highest-pressure storage device increases, and thus, the one or more sensors 114 may trigger an audible or visual alert in response to a predetermined pressure within the highest-pressure storage device being met.

In or more embodiments, the system 100 may further include a control circuit in electronic communication with the one or more sensors 114 and the plurality of stoppage valves 108. In this way, the one or more sensors 114 may be operable to communicate one or more signals to the control circuit indicating that one or more thresholds of the one or more characteristics of the compressible fluid within, exiting, or entering a storage device 102 have been met. Alternatively, the one or more sensors 114 may continuously or regularly communicate information captured by the one or more sensors 114, and the control circuit may determine whether one or more characteristics of the compressible fluid within, exiting, or entering one or more storage devices 102 are above or below predetermined thresholds. Accordingly, the control circuit may be operable to actuate one or more stoppage valves 108 of the plurality of stoppage valves 108 in response to a predetermined threshold being met. To this end, the control circuit may control the flow path through the system 100 in response to the measurements of the one or more sensors 114.

The control circuit may include at least one processor programmed to execute instructions stored on computer-readable media. The control circuit may communicate with the one or more sensors 114, the plurality of stoppage valves 108, and other components of the system 100 described herein by any suitable wired or wireless communication protocols and interfaces such as 4-20 milliamp highway addressable remote transducer (HART) signal, Ethernet, fiber optics, coaxial, infrared, radio frequency (RF), a universal serial bus (USB), Wi-Fi®, cellular network, or the like. The control circuit may be in communication with a user interface to provide real-time feedback of one or more components of the system 100 to an operator. For example, the user interface may provide real-time feedback of one or more characteristics of each storage device 102 of the system 100 and the current configurations of each stoppage valve 108.

The user interface may take the form of a general computer, a handheld device, a siren, one or more visual indicators placed on one or more components of the system 100 (e.g., a light bar disposed on the exterior of each storage device 102), or an equivalent component designed to output information to an operator. The user interface may output alerts when one or more thresholds of one or more characteristics have been met, one or more stoppage valves 108 have been automatically actuated or are recommended to be manually actuated, a malfunction or obstruction in a component of the system 100 is detected, maintenance of a component of the system 100 is required, etc.

In one or more embodiments, the control circuit is further in electronic communication with the plurality of flow control valves 110. As such, the control circuit may be operable to modulate the plurality of flow control valves 110 to alter the flow rate through one or more flow control valves 110 in response to one or more characteristics of the compressible fluid within, exiting, or entering one or more storage devices 102 meeting a threshold. In one or more embodiments, the control circuit is operable to modulate the plurality of flow control valves 110 in response to a change in the flow path of the system 100.

In one or more embodiments, the control circuit is further in electronic communication with the plurality of chillers 112. As such, the control circuit may be operable to modulate the plurality of chillers 112 to alter an output temperature of one or more chillers 112 in response to one or more characteristics meeting a threshold. In one or more embodiments, the control circuit is operable to modulate the plurality of chillers 112 in response to a change in the flow path of the system 100.

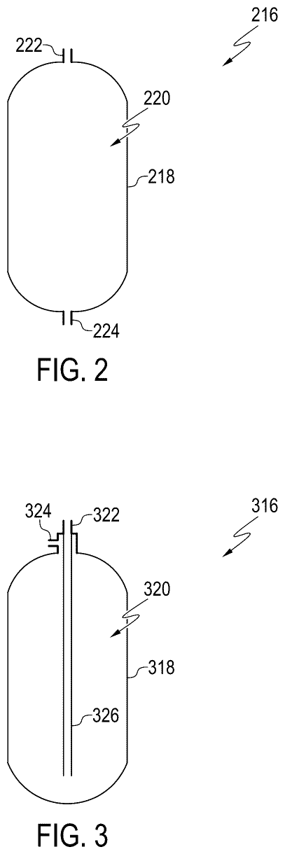

FIG. 2 depicts a schematic diagram of a storage device according to one or more embodiments of the present disclosure. In one or more embodiments, the storage device may be a storage tank 216. In the non-limiting example of FIG. 2, a storage tank 216 includes a main body 218 that is generally hollow defining an interior chamber 220. The main body 218 may be constructed from a strong, rigid material (e.g., steel, carbon fiber, or a combination thereof) suitable to store a compressible fluid at pressures up to 4,000 psig or greater.

In one or more embodiments, the storage tank 216 includes an inlet 222 operable to receive fluid and an outlet 224 operable to deliver fluid. The storage tank 216 may be operable to receive and deliver fluid simultaneously. In the non-limiting example of FIG. 2, the inlet 222 is disposed at a first end of the main body 218 and the outlet 224 is disposed at an opposite, second end of the main body 218.

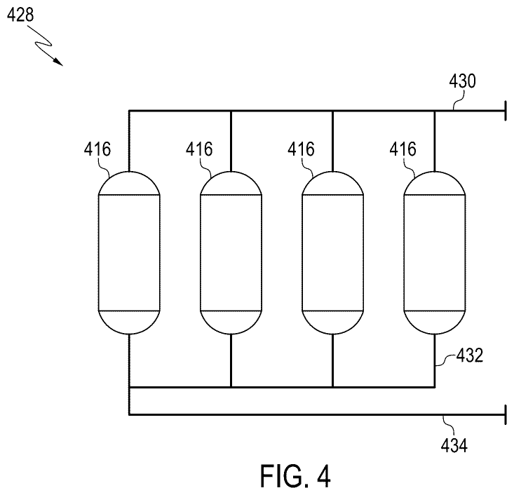

Alternatively, the inlet 322 and the outlet 324 of a storage tank 316 may be disposed at a same end of the main body 318, as depicted in FIG. 3. In addition, the storage tank 316 may further include a conduit 326 operable to extend within the interior chamber 320 from the inlet 322 towards an opposite end of the main body 318. As such, fluid entering the inlet 322 of the storage tank 316 may enter the interior chamber 320 at a predetermined distance from the inlet 322 and the outlet 324. Alternatively, in one or more embodiments, the conduit 326 may instead extend within the interior chamber 320 from the outlet 324 towards an opposite end of the main body 318, such that fluid exiting the storage tank 316 must first enter an end of the conduit 326 set a predetermined distance away from the outlet 324 and the inlet 322. In both examples, the conduit 326 serves to promote a mixing of the compressible fluid entering the storage tank 316 with the fluid already disposed within the interior chamber 320. In addition, the conduit 326 serves to prevent fluid from flowing directly from the inlet 322 to the outlet 324 without first mixing with the fluid already disposed in the interior chamber 320.

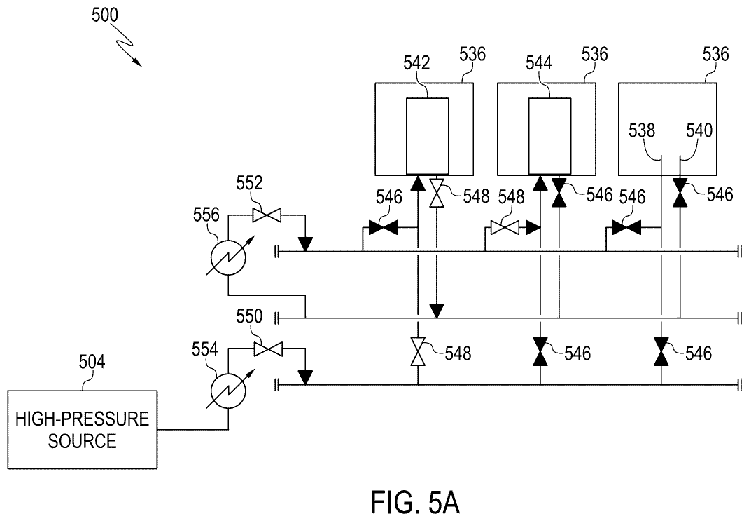

FIG. 4 depicts another embodiment of a storage device according to one or more embodiments of the present disclosure. In the non-limiting example of FIG. 4, the storage device includes a storage tank array 428. The storage tank array 428 includes a plurality of storage tanks 416 fluidly connected in parallel between a first manifold 430 and a second manifold 432. The storage tanks 416 of the storage tank array 428 may be of any form, including either of the storage tanks 216, 316 depicted in FIGS. 2 and 3.

The first manifold 430 of the storage tank array 428 is operable to be in fluid communication with the inlet of each storage tank 416 of the plurality of storage tanks 416 of the storage tank array 428. In addition, the first manifold 430 is operable to be in fluid communication with one or more flow lines of the flow line network. As such, the first manifold 430 is operable to deliver fluid from the flow line network to the inlet of each storage tank 416 of the plurality of storage tanks 416 simultaneously. Further, the second manifold 432 of the storage tank array 428 is operable to be in fluid communication with the outlet of each storage tank 416 of the plurality of storage tanks 416 of the storage tank array 428, as well as one or more flow lines of the flow line network. Accordingly, the second manifold 432 is operable to deliver fluid from the outlet of each storage tank 416 of the plurality of storage tanks 416 to the flow line network simultaneously.

In the non-limiting example of FIG. 4, the second manifold 432 includes a flow equalization line 434 in the form of a “doubled-back” line. The flow equalization line 434 may be operable to promote equal flow distribution through the outlet of each storage tank 416 of the plurality of storage tanks 416 in fluid communication with the second manifold 432. In one or more embodiments, the first manifold 430 may instead or additionally include a flow equalization line 434 that is operable to promote equal flow distribution through the inlet of each storage tank 416 of the plurality of storage tanks 416 in fluid communication with the first manifold. Accordingly, flow equalization lines 434 may be employed to promote approximately equal flow from the first manifold 430 into each of the storage tanks 416 and to promote approximately equal flow out of each storage tank 416 into the second manifold 432.

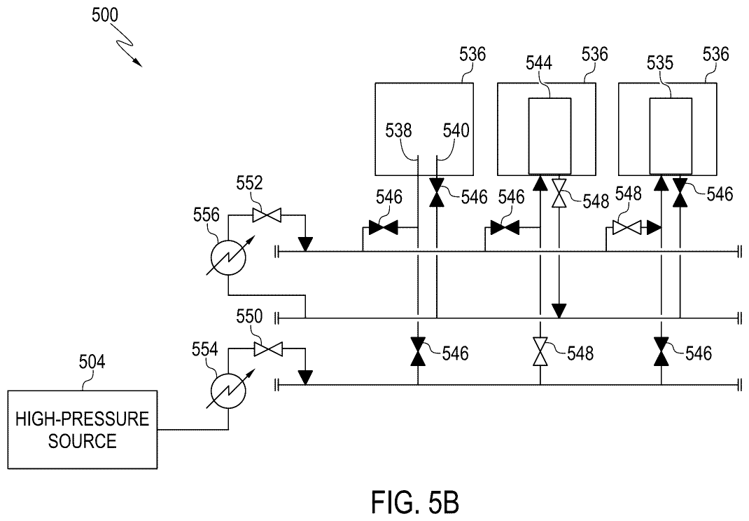

FIGS. 5A-5B provide an overview of an operational sequence of a filling operation employing a system 500 according to one or more embodiments of the present disclosure. Components shown in FIG. 1 may not be redescribed for purposes of readability but have the same description and purpose as outlined above.

As discussed above, a plurality of stoppage valves of a system 500 is operable to control a flow path through the system 500 such that two or more storage devices of a plurality of storage devices of the system 500 are fluidly connected in a series. In addition, the flow path may be modified by actuation of one or more stoppage valves in response to one or more characteristics of one or more storage devices meeting a threshold. To this end, as the flow path is altered, one or more storage devices previously part of the series may be removed from the series. That is, one or more stoppage valves may be actuated into a closed configuration in order to fluidly disconnect one or more storage devices from the series. Further, as the flow path is altered, one or more additional storage devices 535 previously not part of the series may be added to the series. That is, one or more stoppage valves may be actuated into an open configuration in order to fluidly connect one or more additional storage devices 535 to the series.

The system 500 depicted in FIGS. 5A-5B further includes a plurality of bays 536. Each bay 536 of the plurality of bays 536 is a designated area for a storage device to be connected to the system 500. In one or more embodiments, each bay 536 includes an inlet line 538 operable to fluidly connect an inlet or a first manifold of a storage device to the flow line network of the system 500. In addition, each bay 536 may include an outlet line 540 operable to fluidly connect an outlet or a second manifold of a storage device to the flow line network of the system 500. In one or more embodiments, the plurality of stoppage valves is operable to control the flow of fluid through the inlet line 538 and the outlet line 540 of each bay 536.

In one or more embodiments, the number of bays 536 included in the plurality of bays 536 is greater than the number of storage devices fluidly connected to the flow line network of the system 500. As such, one or more bays 536 may be empty of a storage device. Further, one or more additional storage devices 535 may be disposed within or fluidly connected to one or more bays 536 without being in fluid communication with the flow path. That is, one or more stoppage valves of the plurality of stoppage valves of the system 500 may prevent fluid communication between the flow path and one or more additional storage devices 535 disposed within or fluidly connected to one or more bays 536. In this way, fluid communication between the one or more additional storage devices 535 and the flow path may be provided quickly upon actuation of one or more stoppage valves.

In one or more embodiments, each storage device of the plurality of storage devices may be coupled to a vehicle. A vehicle should be understood as to include any method of ground-based transportation for compressible fluid storage equipment known in the art (e.g., a truck, a crane, etc.). In one or more embodiments, a vehicle is operable to transport a storage device to an empty bay 536 of the system 500. Upon arrival of the empty bay 536, the storage device may be fluidly connected to the bay 536, and thus, the flow line network of the system 500. In one or more embodiments, the storage device may be decoupled from the vehicle subsequent to the storage device being fluidly connected to the flow line network. In one or more embodiments, a vehicle is operable to transport a storage device away from the system 500. That is, a storage device may be coupled to the vehicle and, subsequent to the storage device being fluidly disconnected from the flow line network of the system 500, transported to a location away from the system 500 by the vehicle.

In the non-limiting example of FIG. 5A, the system 500 initially includes two storage devices (e.g., an initial highest-pressure storage device 542 and an initial lowest-pressure storage device 544) disposed in separate bays 536. In addition, the system 500 includes an empty bay 536 initially void of a storage device. The plurality of stoppage valves of the system 500 of FIG. 5A include a plurality of stoppage valves in a closed configuration (e.g., closed stoppage valves 546) and a plurality of stoppage valves in an open or partially open configuration (e.g., open stoppage valves 548). Accordingly, fluid is prevented from passing through the closed stoppage valves 546 and is permitted to flow through the open stoppage valves 548. In FIG. 5A, the closed stoppage valves 546 and the open stoppage valves 548 create a flow path through the system 500 such that the highest-pressure storage device 542 and the lowest-pressure storage device 544 are fluidly connected in a series. Further, the flow path created by the closed stoppage valves 546 and the open stoppage valves 548 provides fluid communication between the high-pressure source 504 and the upstream end of the series (e.g., the highest-pressure storage device 542). Furthermore, the closed stoppage valves 546 prevent fluid communication between the flow path and the empty bay 536.

The system 500 of FIG. 5A further includes a plurality of flow control valves and a plurality of chillers. A first flow control valve 550 of the plurality of flow control valves is fluidly connected to the flow path between the high-pressure source 504 and the highest-pressure storage device 542. A second flow control valve 552 of the plurality of flow control valves is fluidly connected to the flow path between the highest-pressure storage device 542 and the lowest-pressure storage device 544. Similarly, a first chiller 554 of the plurality of chillers is thermally connected to the flow path between the high-pressure source 504 and the highest-pressure storage device 542, and a second chiller 556 of the plurality of chillers is thermally connected to the flow path between the highest-pressure storage device 542 and the lowest-pressure storage device 544.

During a filling operation of the system 500 of FIG. 5A, compressible fluid is delivered from high-pressure source 504 to the highest-pressure storage device 542. The flow rate and the temperature of this portion of fluid is controlled by the first flow control valve 550 and the first chiller 554, respectively, as the portion of fluid is delivered to the highest-pressure storage device 542. Simultaneously, a portion of compressible fluid is delivered from the highest-pressure storage device 542 to the lowest-pressure storage device 544. The flow rate and the temperature of this portion of fluid is controlled by the second flow control valve 552 and the second chiller 556, respectively, as the portion of fluid is delivered to the lowest-pressure storage device 544.

In one or more embodiments, the flow rate of the first flow control valve 550 is greater than the flow rate of the second flow control valve 552. As such, compressible fluid is received by the highest-pressure storage device 542 at a rate that is greater than the rate at which fluid is delivered downstream from the highest-pressure storage device 542. Thus, the density of the compressible fluid within each storage device (e.g., the highest-pressure storage device 542 and the lowest-pressure storage device 544) increases during the filling operation.

Compressible fluid may be continuously delivered to the series from the high-pressure source 504 until one or more characteristics of the fluid within, exiting, or entering the highest-pressure storage device 542 meet a threshold. For example, compressible fluid may be continuously delivered to the series from the high-pressure source 504 until a pressure within the highest-pressure storage device 542 reaches a predetermined pressure. Subsequently, one or more of the open stoppage valves 548, one or more of the closed stoppage valves 546, or a combination thereof are automatically or manually actuated to fluidly disconnect the highest-pressure storage device 542 from the flow path of the system 500. In this way, the highest-pressure storage device 542 is fluidly disconnected from the series and from the high-pressure source 504, as depicted in FIG. 5B.

In one or more embodiments, the highest-pressure storage device 542 may be removed from the system 500 subsequent to the highest-pressure storage device 542 being fluidly disconnected from the flow path, as depicted in FIG. 5B. For example, subsequent to the highest-pressure storage device 542 being fluidly disconnected from the flow path, the highest-pressure storage device 542 may be transported away from the system 500 by a vehicle coupled to the highest-pressure storage device 542. As a result, the bay 536 in which the highest-pressure storage device 542 was previously disposed may become an empty bay 536.

In one or more embodiments, an additional storage device 535 may be transported to the previously empty bay 536 by a vehicle subsequent to the highest-pressure storage device 542 being fluidly disconnected from the flow path. To this end, the additional storage device 535 may be fluidly connected to the flow path subsequent to the highest-pressure storage device 542 being fluidly disconnected from the flow path. As such, after the additional storage device 535 is fluidly connected to the flow line network, one or more closed stoppage valves 546, one or more open stoppage valves 548, or a combination thereof are actuated to modify the flow path of the system 500. The plurality of stoppage valves (e.g., the open stoppage valves 548 and the closed stoppage valves 546) is operable to modify the flow path such that the additional storage device 535 and the lowest-pressure storage device 544 are connected in a series with the upstream end of the series being fluidly connected to the high-pressure source 504.

Alternatively, in one or more embodiments, an additional storage device 535 may be transported to the previously empty bay 536 by a vehicle prior to the highest-pressure storage device 542 being fluidly disconnected from the flow path. As such, the additional storage device 535 may be fluidly connected to the flow path as the highest-pressure storage device 542 is fluidly disconnected from the flow path. Further, one or more closed stoppage valves 546, one or more open stoppage valves 548, or a combination thereof are actuated to modify the series of the system 500 such that the series now includes the additional storage device 535 and the lowest-pressure storage device 544. In this way, the high-pressure source 504 may continue to deliver fluid to the upstream end of the series with minimal or no interruption.

In one or more embodiments, the newly added additional storage device 535 includes a compressible fluid at a lower pressure than the initial lowest-pressure storage device 544. As such, upon the connection of the additional storage device 535 to the flow path, the additional storage device 535 becomes the new lowest-pressure storage device and the initial lowest-pressure storage device 544 becomes the new highest-pressure storage device. Thus, the upstream end of the series formed by the modified flow path of the system 500 may be the new highest-pressure storage device (e.g., initial lowest-pressure storage device 544) and the downstream end of the series formed by the modified flow path may be the new lowest pressure storage device (e.g., the additional storage device 535).

Subsequent to the additional storage device 535 being fluidly connected to the system 500 and the modification of the flow path of the system 500, the filling operation resumes with the system 500 of FIG. 5B. During the filling operation of the system 500 of FIG. 5B, compressible fluid is delivered from the high-pressure source 504 to the new highest-pressure storage device. The flow rate and the temperature of this portion of fluid is controlled by the first flow control valve 550 and the first chiller 554, respectively, as the portion of fluid is delivered from the high-pressure source 504. Simultaneously, a portion of compressible fluid is delivered from the new highest-pressure storage device to the new lowest-pressure storage device (e.g., the additional storage device 535). The flow rate and the temperature of this portion of fluid is controlled by the second flow control valve 552 and the second chiller 556, respectively, as the portion of fluid is delivered to the new lowest-pressure storage device.

Compressible fluid may be continuously delivered to the series from the high-pressure source 504 until one or more characteristics of the fluid within, exiting, or entering the new highest-pressure storage device meet a threshold. Subsequently, one or more of the open stoppage valves 548, one or more of the closed stoppage valves 546, or a combination thereof is automatically or manually actuated to fluidly disconnect the new highest-pressure storage device from the series, as well as fluidly connect another additional storage device 535 to the series. As such the operational sequence depicted in FIGS. 5A-5B may be continuously repeated.

In one or more embodiments, the system 500 may initially include two or more storage devices of equal pressure disposed in separate bays 536. Here, the flow path of the system 500 may be arranged by one or more stoppage valves (e.g., one or more closed stoppage valves 546 and one or more open stoppage valves 548) such that fluid is delivered from the high-pressure source 504 to a single storage device until one or more characteristics of the fluid within or entering this single storage device meet a threshold. As a result of the one or more characteristics of the fluid within or entering this single storage device meeting a threshold, the single storage device becomes the highest-pressure storage device 542 of the system 500. In addition, one or more stoppage valves are actuated to fluidly connect another storage device of the initial storage devices to the flow path such that the other storage device and the highest-pressure storage device 542 are fluidly connected in a series with the other storage device being the lowest-pressure storage device 544 of the series. Thereafter, the operational sequence may follow that which is described in relation to FIGS. 5A-5B.

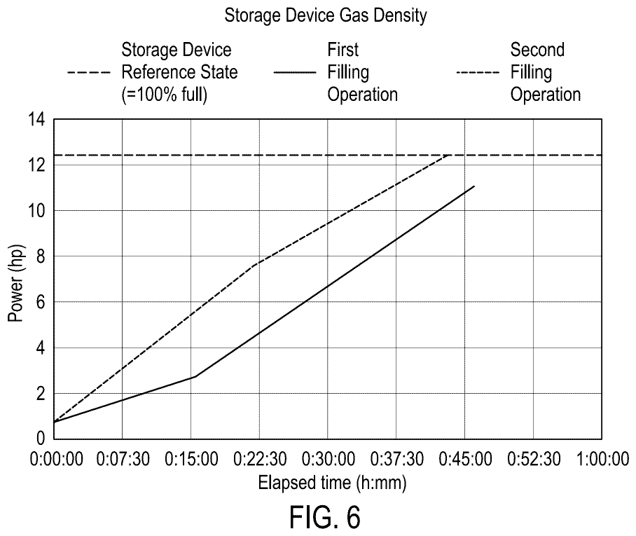

FIGS. 6-8 present graphs which compare example conditions of a first filling operation and a second filling operation. Specifically, FIGS. 6-8 respectively depict graphs of example densities, pressures, and temperatures of natural gas within a CNG storage device of the first filling operation and the second filling operation. Both filling operations are designed to fill storage devices from an inherently high-pressure source of natural gas, such as a wellhead producing high-pressure natural gas. The first filling operation includes a filling operation of a base case (e.g., a single storage device directly and fluidly connected to a high-pressure source). The second filling operation employs a system 500 according to one or more embodiments of the present disclosure (e.g., the filling operation described in relation to FIGS. 5A-5B).

In FIGS. 6-8, the storage device of the second filling operation is the initial lowest-pressure storage device 544 of a series including two storage devices. Initially, the base case storage device of the first filling operation and the lowest-pressure storage device 544 of the second filling operation begin their respective filling operations under similar conditions (e.g., the base case storage device and the lowest-pressure storage device 544 include initial interior temperatures of approximately 50° F. and are nominally empty having initial pressures of approximately 200 psig).

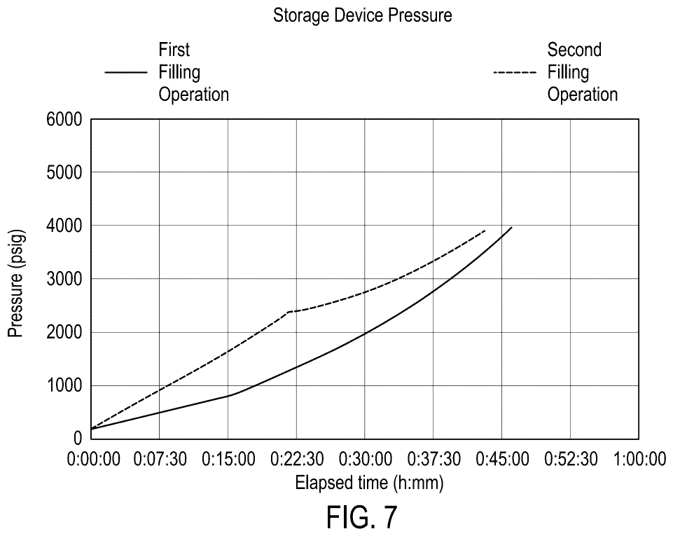

During the first filling operation, gas is delivered from a high-pressure source to the base case storage device at a targeted flow rate of approximately 15 MMscf/d (e.g., FIG. 6). However those skilled in the art will appreciate that during an initial phase of the first filling operation the flow rate at which gas is delivered to the base case storage device is less than the targeted flow rate in order to mitigate cooling of the gas at an outlet of the flow line fluidly connecting the high-pressure source and the base case storage device. After this initial phase of the first filling operation, the flow rate of the gas delivered to the base case storage device is increased to the targeted flow rate. As shown in FIG. 7, the first filling operation proceeds at this targeted flow rate until the pressure within the base case storage device reaches a pressure equivalent to that of the high-pressure source (e.g., approximately 4,000 psig), at which point the first filling operation is halted. At the time the first filling operation is halted (e.g., the time at which the differential pressure between the high-pressure source and the base case storage device decreases to a predetermined pressure, for example approximately 100 psig), the base case storage device is merely approximately 88% full (e.g., a storage device having an interior density of approximately 12.4 lb/ft³ being 100% full).

During a first phase of the second filling operation, gas is delivered to the lowest-pressure storage device 544 from the highest-pressure storage device 542 of the system 500 (e.g., at a flow rate of approximately 17.5 MMscf/d) as previously described in relation to FIG. 5A. Since the lowest-pressure storage device 544 is receiving gas from a much lower pressure source (e.g., the highest-pressure storage device 542) than the base case storage device, the flow rate of the gas delivered to the lowest-pressure storage device 544 is not subject to the same restriction on flow rate during the initial portion of the filling operation as the flow rate of gas delivered to the base case storage device. Simultaneous to gas being delivered to the lowest-pressure storage device 544 from the highest-pressure storage device 542, gas is delivered to the highest-pressure storage device 542 from the high-pressure source 504 (e.g., at a flow rate of approximately 30 MMscf/d). Accordingly, because the highest-pressure storage device 542 delivers and receives gas simultaneously, the rate of accumulation in the highest-pressure storage device 542 is the difference between the flow rate being received by the highest-pressure storage device 542 and the flow rate of the gas being delivered from the highest-pressure storage device 542 (e.g., approximately 12.5 MMscf/d). In this way, the average rate of accumulation in the highest-pressure storage device 542 and the lowest-pressure storage device 544 (e.g., approximately 15 MMscf/d) is equivalent to the targeted flow rate of the gas delivered to the base case storage device during the first filling operation. Further, because the flow rate of gas being received by the lowest-pressure storage device 544 is greater than the flow rate of the gas being received by the base case storage device, the density, and thus the temperature and pressure, of the gas within the lowest-pressure storage device 544 is greater than the respective density, temperature, and pressure of the gas within the base case storage device at any point in time during the first phase of the second filling operation.

In one or more embodiments, the first phase of the second filling operation concludes subsequent to one or more characteristics of the highest-pressure storage device 542 meeting a predetermined threshold. Upon conclusion of the first phase of the second filling operation of the system 500, a second phase of the second filling operation of the system 500 begins. During the second phase, an additional storage device 535 storing gas at a pressure less than the current pressure of the gas within the initial lowest-pressure storage device 544 is fluidly connected to the flow path of the system 500. In addition, during the second phase, the initial highest-pressure storage device 542 is fluidly disconnected from the flow path of the system 500. As such, the initial lowest-pressure storage device 544 becomes the new highest-pressure storage device and the additional storage device 535 becomes the new lowest-pressure storage device as previously described in relation to FIG. 5B. To this end, during the second phase of the second filling operation, the new highest-pressure storage device (e.g., the initial lowest-pressure storage device 544) receives gas directly from the high-pressure source 504 (e.g., at a flow rate of approximately 30 MMscf/d) and the new lowest-pressure storage device (e.g., the additional storage device 535) receives gas from the new highest-pressure storage device (e.g., at a flow rate of approximately 17.5 MMscf/d).

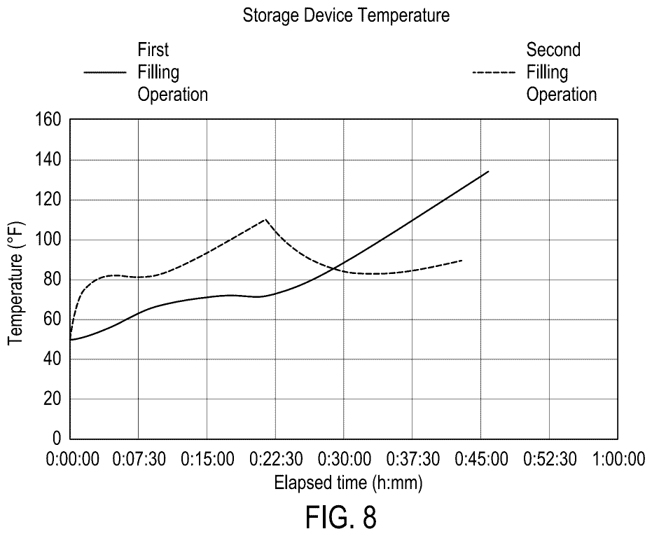

As shown in FIG. 6, the rate of accumulation in the new highest-pressure storage device (e.g., the initial lowest-pressure storage device 544) decreases during the second phase of the second filling operation compared to the first phase of the second filling operation. In addition, because the new-highest pressure storage device receives cooled gas and dispenses gas simultaneously, the temperature within the new-highest pressure storage device begins to decrease during the second phase as shown in FIG. 8. As such, the average rate at which the pressure within the new highest-pressure storage device increases is lower in the second phase compared to the first phase as shown in FIG. 7. In this way, because the pressure of the gas within the new highest-pressure storage device remains below a pressure of the gas supplied by the high-pressure source 504 (e.g., approximately 4,000 psig), there exists a pressure differential between the new-highest pressure storage device and the high-pressure source 504 greater than a predetermined pressure differential (e.g., approximately 100 psi). The predetermined pressure differential may be a pressure differential sufficient to overcome fluid resistance in the flow line network and all associated and upstream equipment at a targeted flow rate. Thus, gas may continue to be received by the new-highest pressure storage device at a targeted rate of accumulation until the new highest-pressure storage device becomes approximately 100% full (e.g., having an interior density of approximately 12.4 lb/ft³).

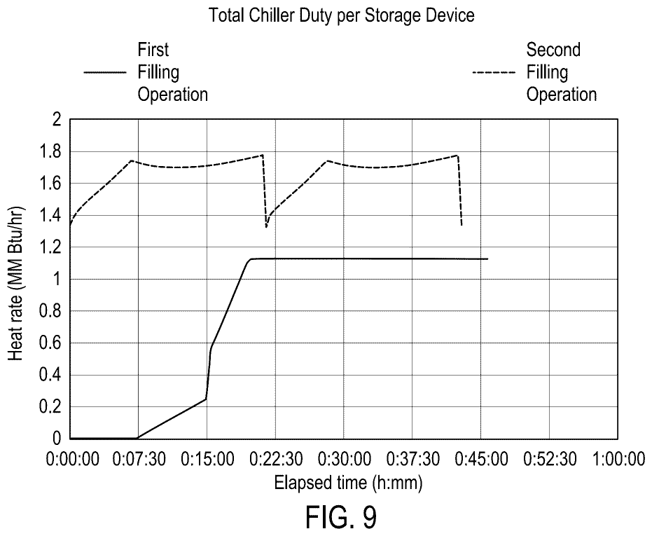

FIG. 9 presents a graph which compares example total chilling duties during the first filling operation and the second filling operation. The variation in total chilling duties between the first filling operation and the second filling operation should be readily apparent to those of ordinary skill in the art.

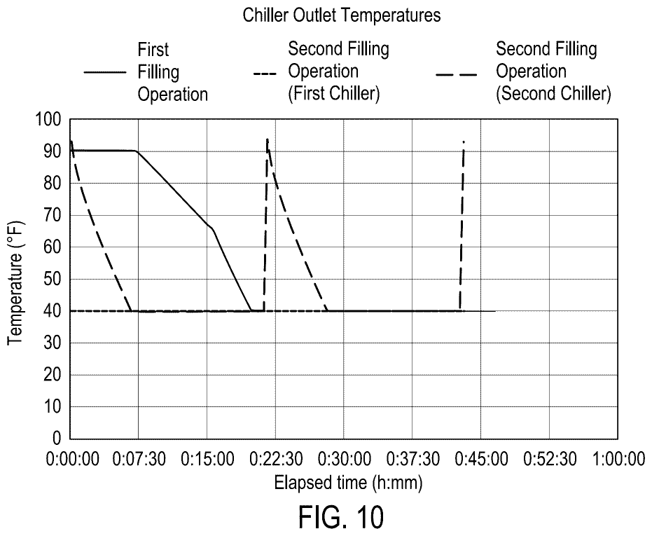

In the first filling operation, the gas delivered to the base case storage device from the high-pressure source is cooled by a cooling device from approximately 90° F. to either a first temperature (e.g., a predetermined temperature, for example approximately 40° F.) or a second temperature (e.g., the minimum temperature that would keep the temperature at the outlet of the flow line fluidly connecting the high-pressure source and the base case storage device above the minimum operating temperature of the flow line, such as a minimum operating temperature of approximately −40° F.). The cooling device may cool the gas delivered from the high-pressure source to the first temperature or the second temperature depending on whichever of the first temperature or the second temperature is higher at any given time. Similarly, in the second operation, the gas delivered from the high-pressure source 504 to the most upstream storage device in the series (e.g., the highest-pressure storage device 542 during the first phase and the new highest-pressure storage device during the second phase) is cooled by a first chiller 554 from approximately 90° F. to either a first temperature (e.g., a predetermined temperature, for example approximately 40° F.) or a second temperature (e.g., the minimum temperature that would keep the temperature at the outlet of the flow line fluidly connecting the high-pressure source 504 and the most upstream storage device in the series above the minimum operating temperature of the flow line, such as a minimum operating temperature of approximately −40° F.). The first chiller 554 may cool the gas delivered from the high-pressure source 504 to the first temperature or the second temperature depending on whichever of the first temperature or the second temperature is higher at any given time. In addition, the gas delivered to the most downstream storage device (e.g., the lowest-pressure storage device 544 during the first phase and the new lowest-pressure storage device during the second phase) from a sequentially upstream storage device in the series is cooled by a second chiller 556. The second chiller 556 may also cool the gas delivered to the most downstream storage device in the series to either a first temperature (e.g., a predetermined temperature, for example approximately 40° F.) or a second temperature (e.g., the minimum temperature that would keep the temperature at the outlet of the flow line fluidly connecting the most downstream storage device and a sequentially upstream storage device in the series above the minimum operating temperature of the flow line, such as a minimum operating temperature of approximately −40° F.). The second chiller 556 may cool the gas received by the most downstream storage device in the series to the first temperature or the second temperature depending on whichever of the first temperature or the second temperature is higher at any given time. Example outlet temperatures for the cooling device of the first filling operation and for the plurality of chillers of the second filling operation (e.g., the first chiller 554 and the second chiller 556) are depicted in FIG. 10.

In one or more embodiments (e.g., FIGS. 5A-5B), the positions of the first chiller 554 and the second chiller 556 within the system 500 do not change as storage devices are fluidly connected and fluidly disconnected from the series. To this end, as shown in the example of FIG. 9, the total chilling duty profiles of the plurality of chillers during each phase of the second filling operation may be substantially similar as each phase includes cooling gas delivered from the high-pressure source 504 to the most upstream storage device of the series with a first chiller 554 and cooling gas delivered to the most downstream storage device from a sequentially upstream storage device with a second chiller 556.

As illustrated by FIG. 9, the maximum instantaneous chilling duty over the course of each phase of the second filling operation is not substantially greater than the average chilling duty of each phase of the second filling operation. Consequently, because the maximum instantaneous chilling duty and the average chilling duty of each phase of the second filling operation are relatively similar, the sizing of the chillers (e.g., the first chiller 554 and the second chiller 556) may be advantageously capital-efficient. However, if the maximum instantaneous chilling duty was significantly greater than the average chilling duty of each phase of the second filling, the maximum instantaneous chilling duty demand would likely require larger or more costly chillers.

In addition, while conventional filling operations may require high-grade cooling devices (e.g., cooling devices operable to cool the delivered gas to temperatures such as −10° F. or lower) to achieve a 100% fill, the second filling operation is operable achieve a 100% fill while employing lower-grade cooling devices (e.g., chillers having a minimum output temperature of approximately 40° F.). Thus, the chillers of the second filling operation (e.g., the first chiller 554 and the second chiller 556) may be advantageously capital-efficient.

Further, since the rates of accumulation of the storage devices of the second filling operation are non-uniform (e.g., the rate of accumulation of the initial highest-pressure storage device 542 is approximately 12.5 MMscf/d and the rate of accumulation of the initial lowest-pressure storage device 544 is approximately 17.5 MMscf/d), the flow rates of the gas received by the storage devices of the second filling operation (e.g., the initial highest-pressure storage device 542 receives gas at a flow rate of approximately 30 MMscf/d and the initial lowest-pressure storage device 544 receives gas at a flow rate of approximately 17.5 MMscf/d) may be greater than if the rates of accumulation of the storage devices of the second filling operation were uniform (e.g., the rates of accumulation of both the initial highest-pressure storage device 542 and the initial lowest-pressure storage device 544 being approximately 15 MMscf/d). In this way, the non-uniform rates of accumulation of the second filling operation advantageously permit the chillers (e.g., the first chiller 554 and the second chiller 556) to remove more heat from the system 500 than if the rates of accumulation of the second filling operation were uniform due to the increase in flow through the chillers.

In the examples of FIGS. 6-10, the duration of each phase of the second filling operation is approximately 43 minutes. However, this time may be longer or shorter depending on several different variables of the system 500 (e.g., the initial conditions of the gas within the storage devices, the flow rate of gas being delivered from each storage device, etc.). In one or more embodiments, each phase of the second filling operation concludes subsequent to one or more characteristics of the gas of the most upstream storage device of the series meeting a predetermined threshold. For example, the first phase of the second filling operation of the system 500 concludes subsequent to the highest-pressure storage device 542 being deemed sufficiently or nominally fully of gas (e.g., having an interior pressure of approximately 12.4 lb/ft³). In one or more embodiments, one or more phases may conclude subsequent to the pressure differential between the most upstream storage device of the series and the high-pressure source 504 falling below a predetermined pressure (e.g., approximately 100 psig).

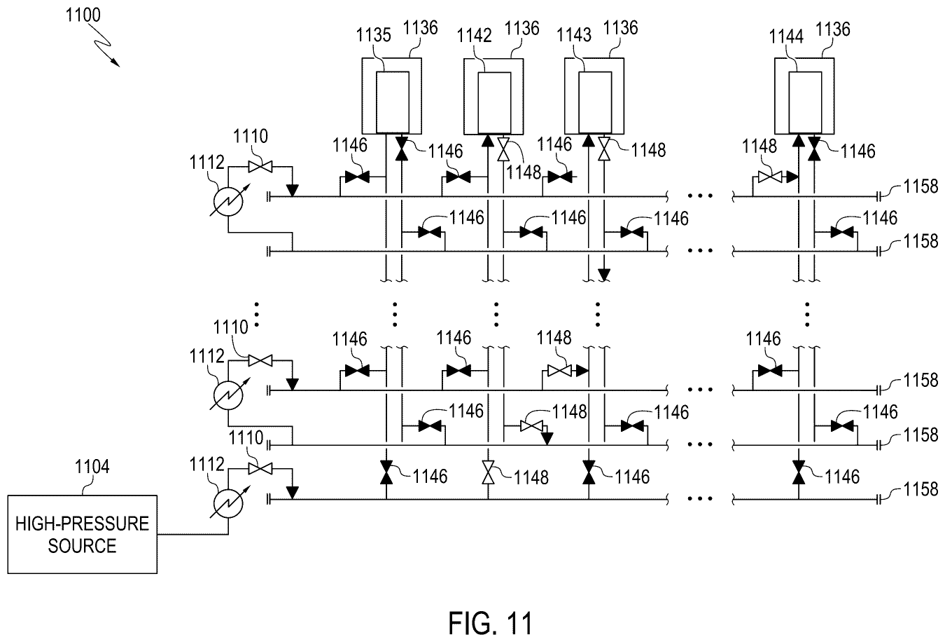

FIG. 11 depicts another embodiment of a system 1100 according to one or more embodiments of the present disclosure. Components shown in FIGS. 1 and 5A-5B may not be redescribed for purposes of readability but have the same description and purpose as outlined above.

In one or more embodiments, a system 1100 may include a plurality of storage devices fluidly connected to a high-pressure source 1104 by a flow line network. The plurality of storage devices may include a number “N” of storage devices fluidly connected in a series by a plurality of stoppage valves (e.g., one or more closed stoppage valves 1146 and one or more open stoppage valves 1148) in fluid communication with the flow line network. The series may be arranged sequentially from a highest-pressure storage device 1142 of the plurality of storage devices to a lowest-pressure storage device 1144 of the plurality of storage devices.

In one or more embodiments, the flow line network of the system 1100 may include a plurality of fluidly connected headers 1158. For example, in one or more embodiments, the system 1100 includes at least 2N−1 headers 1158. In one or more embodiments, each storage device of the series may be fluidly connected to each header 1158.

In one or more embodiments, the system 1100 includes at least N flow control valves 1110 in fluid communication with one or more headers 1158. In this way, at least one flow control valve 1110 is fluidly coupled to the flow path upstream of each storage device such that the flow rate of the compressible fluid entering each storage device in the series may be controlled prior to the fluid being received from a sequentially upstream storage device in the series or the high-pressure source 1104.

In one or more embodiments, the system 1100 includes at least N chillers 1112 in thermal communication with one or more headers 1158. In this way, at least one chiller 1112 is thermally coupled to the flow path upstream of each storage device such that compressible fluid entering each storage device in the series may be cooled prior to the fluid being received from a sequentially upstream storage device in the series or the high-pressure source 1104. In one or more embodiments, each chiller 1112 may share a same minimum outlet temperature.

In one or more embodiments, the system 1100 includes a plurality of bays 1136. In one or more embodiments, the plurality of bays 1136 includes at least N+1 bays 1136. In this way, one or more additional storage devices 1135 may be disposed within or fluidly connected to one or more bays 1136 without being in fluid communication with the flow path. As such, a system 1100 including at least N+1 bays 1136 may provide operational convenience by enabling one or more additional storage devices 1135 to be instantaneously connected to the series by actuation of one or more stoppage valves.

In one or more embodiments, each bay 1136 of the system 1100 may be fluidly connected to each header 1158. As such, in one or more embodiments, the number of stoppage valves of the system 1100 is equivalent to at least the product of the number of headers 1158 (e.g., at least 2N−1) and the number of bays 1136 (e.g., at least N+1). In this way, fluid communication between each bay 1136 and each header 1158 may be controlled by the plurality of stoppage valves.

In one or more embodiments, the plurality of stoppage valves is operable to control the flow path of the system 1100 such that each storage device of the series may only be in fluid communication with two or fewer headers 1158 at a time. For example, as depicted in FIG. 11, the stoppage valves (e.g., one or more closed stoppage valves 1146 and one or more open stoppage valves 1148) create a flow path such that the lowest-pressure storage device 1144 only receives compressible fluid from a single header 1158, while each other storage devices of the series (e.g., the highest-pressure storage device 1142) receives fluid from one header 1158 and delivers fluid to a different header 1158. In one or more embodiments, each header 1158 may only be in fluid communication with a single storage device at a time.

The flow path of the system 1100 may be modified by actuation of one or more stoppage valves in response to one or more characteristics of the compressible fluid within, exiting, or entering the one or more storage devices meeting a threshold. To this end, as the flow path is altered, one or more storage devices previously part of the series may be removed from the series. That is, one or more stoppage valves may be actuated into a closed configuration in order to fluidly disconnect one or more storage devices from the series. Further, as the flow path is altered, one or more additional storage devices 1135 previously not part of the series may be added to the series. That is, one or more stoppage valves may be actuated into an open configuration in order to fluidly connect one or more additional storage devices 1135 to the series.

In one or more embodiments (e.g., FIG. 11), as the flow path of the system 1100 is modified in order to fluidly connect and fluidly disconnect storage devices from the series, the positions of each flow control valve 1110 and each chiller 1112 along the flow path remain constant. That is, each flow control valve 1110 and each chiller 1112 may be associated with a stage or phase of the series rather than particular storage devices or bays 1136. For example, the stoppage valves may modify the flow path such that a first flow control valve 1110 and a first chiller 1112 may always be coupled to the flow path between the high-pressure source 1104 and the most upstream storage device of the series while an Nth flow control valve 1110 and an Nth chiller 1112 may always be coupled to the flow path between the most downstream storage device of the series and the storage device sequentially upstream in the series from the most downstream storage device.

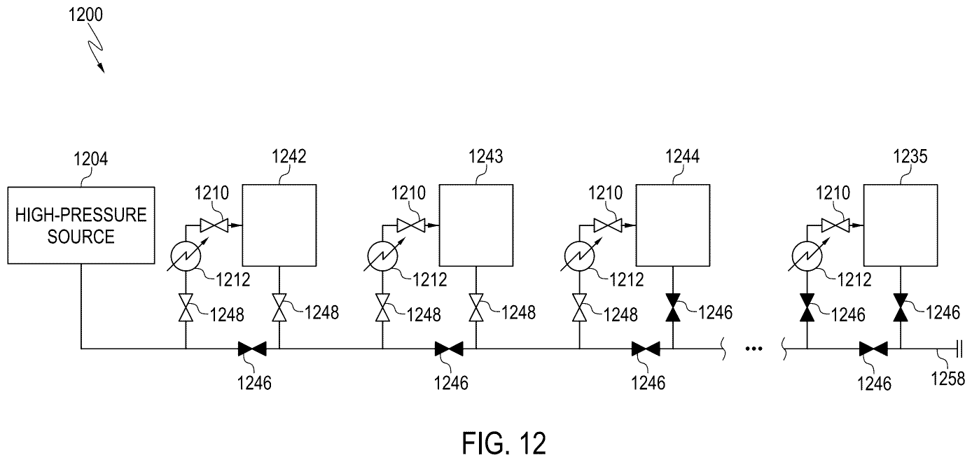

FIG. 12 depicts another embodiment of a system 1200 according to one or more embodiments of the present disclosure. Components shown in FIGS. 1, 5A-5B, and 11 may not be redescribed for purposes of readability but have the same description and purpose as outlined above.

In one or more embodiments, a system 1200 may include a plurality of storage devices fluidly connected to a high-pressure source 1204 by a flow line network. The plurality of storage devices may include a number “N” of storage devices fluidly connected in a series by a plurality of stoppage valves (e.g., one or more closed stoppage valves 1246 and one or more open stoppage valves 1248) in fluid communication with the flow line network. The series may be arranged sequentially from a highest-pressure storage device 1242 of the plurality of storage devices to a lowest-pressure storage device 1244 of the plurality of storage devices.

In a system 1200 including a series of three storage devices, a filling operation may simultaneously include compressible fluid being delivered from a high-pressure source 1204 to a highest-pressure storage device 1242 of the series at a first flow rate, fluid being delivered from the highest-pressure storage device 1242 to a sequentially downstream storage device (e.g., a middle-pressure storage device 1243) of the series at a second flow rate, and fluid being delivered from the middle-pressure storage device 1243 to a lowest-pressure storage device 1244 of the series at a third flow rate. In one or more embodiments, the rate of fluid accumulation in each storage device in the series may vary. Alternatively, in one or more embodiments, the rates of fluid accumulation in each storage device in the series may be substantially similar.

The flow path of the system 1200 may be modified by actuation of one or more stoppage valves in response to one or more characteristics of the compressible fluid within, exiting, or entering the one or more storage devices meeting a threshold. To this end, as the flow path is altered, one or more storage devices previously part of the series may be removed from the series, and one or more additional storage devices 1235 previously not part of the series may be added to the series. In the non-limiting example of FIG. 12, the flow line network of the system 1200 includes a single pipe header 1258. As such, additional storage devices 1235 may be fluidly connected to the flow line network of the system 1200 downstream of the lowest-pressure storage device 1244.

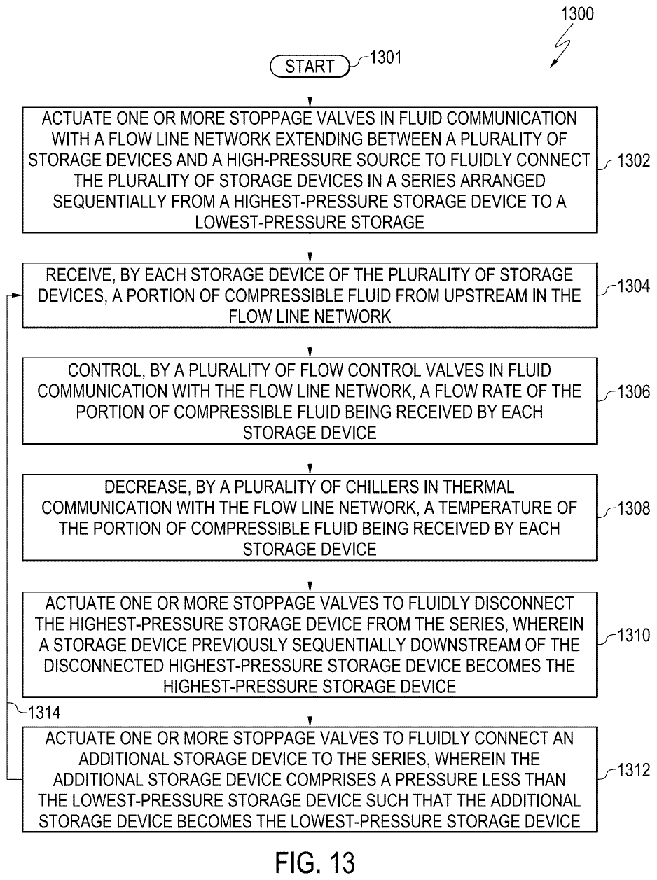

FIG. 13 depicts a logic flow diagram of a method 1300 according to one or more embodiments of the present disclosure. Specifically, the method 1300 describes a filling operation of a plurality of storage devices 102 employing a system 100 according to one or more embodiments of the present disclosure. While the various functions described in FIG. 13 are presented and described sequentially, one of ordinary skill in the art will appreciate that some or all of the steps may be executed in different orders, may be combined or omitted, and some or all of the steps may be executed in parallel. Furthermore, the steps may be performed actively or passively.

Initially, one or more stoppage valves 108 of a plurality of stoppage valves 108 of a system 100 are actuated 1302 to create a flow path fluidly connecting a plurality of storage devices 102 of the system 100 in a series. The plurality of stoppage valves 108 may be in fluid communication with a flow line network extending between the plurality of storage devices 102 and a high-pressure source 104. As such, one or more stoppage valves 108 may be actuated such that the high-pressure source 104 is fluidly connected to an upstream end of the series. The series may be arranged sequentially from a highest-pressure storage device of the plurality of storage devices 102 to a lowest-pressure storage device of the plurality of storage devices 102.

Subsequently, a portion of compressible fluid from upstream in the flow line network is delivered to and received 1304 by each storage device 102 of the plurality of storage devices 102 such that the portion of fluid received by the highest-pressure storage device is transported from the high-pressure source 104 and the portion of compressible fluid received by the lowest-pressure storage device is transported from a sequentially upstream storage device in the series. A flow rate of the portion of fluid being received by each storage device 102 is controlled 1306 by a plurality of flow control valves 110 in fluid communication with the flow line network. In addition, a temperature of the portion of fluid being received by each storage device 102 is decreased 1308 by a plurality of chillers 112 in thermal communication with the flow line network.

In one or more embodiments, a flow control valve 110 and a chiller 112 may be coupled to the flow path upstream of each storage device 102 in the series. In one or more embodiments, the flow rate of the portion of fluid being delivered decreases after each storage device 102 by the plurality of flow control valves 110. In one or more embodiments, one or more chillers 112 of the plurality of chiller 112 includes a same outlet temperature.

One or more stoppage valves 108 are actuated 1310 in order to fluidly disconnect the highest-pressure storage device from the flow path. That is, one or more stoppage valves 108 may be actuated into a closed configuration in order to fluidly disconnect one or more storage devices 102 from the series. Further, one or more stoppage valves 108 are actuated to modify the flow path such that a storage device 102 previously sequentially downstream of the disconnected highest-pressure storage device becomes the highest-pressure storage device, and thus, the upstream end of the series. In this way, the storage device 102 previously sequentially downstream of the disconnected highest-pressure storage device becomes fluidly connected to the high-pressure source 104.

In addition, one or more stoppage valves 108 are actuated 1312 in order to fluidly connect an additional storage device to the flow path. The additional storage device comprises a pressure less than the lowest-pressure storage device. As such, that the additional storage device is fluidly connected to the flow path such that the additional storage device becomes the lowest-pressure storage device, and thus, the downstream end of the series.

In one or more embodiments, the actuation 1310, 1312 of one or more stoppage valves 108 is in response to one or more characteristics of a portion of compressible fluid within, exiting, or entering one or more storage devices 102 meeting a threshold. The one or more characteristics of the portion of compressible fluid within, exiting, or entering each storage device 102 may be measured by one or more sensors 114 of the system 100.

In one or more embodiments, a vehicle may transport the additional storage device to the system 100 from another location away from the system 100 prior to the additional storage device being connected to the flow path. In one or more embodiments, a vehicle may transport a disconnected storage device to another location away from the system 100 subsequent to the storage device being disconnected from the flow path. In one or more embodiments, the disconnected storage device may be transported to a low-pressure demand (e.g., a distribution pipeline, an engine, an electrical generator, a chemical process, etc.) in order to dispense compressible fluid stored within the storage device. As such, subsequent to the compressible fluid within the disconnected storage device being drawn down to a predetermined pressure, the disconnected storage device becomes an additional storage device and may be returned to and connected to the system 100.

Subsequent to an additional storage device being fluidly connected to the flow path by the actuation 1312 of one or more stoppage valves 108, the method may restart 1314.

While various embodiments of systems 100, 500, 1100, 1200 and methods 1300 were provided in the foregoing description, those skilled in the art may make modifications and alterations to these aspects without departing from the scope of the claimed subject matter. For example, it is to be understood that this disclosure contemplates that, to the extent possible, one or more features of any aspect can be combined with one or more features of any other aspect. As another non-limiting specific example, because natural gas is often odorless, as those of ordinary skill in the art will appreciate it is customary to add an odorant, such as ethyl mercaptan, so that a gas leak can be detected anywhere the gas is being processed or consumed. Therefore, such an odorant can be added to any of the gas products produced in accordance with the present disclosure. Accordingly, the foregoing description is intended to be illustrative rather than restrictive. The present disclosure described hereinabove is defined by the appended claims, and all changes to the aspects described in the present disclosure that fall within the meaning and the range of equivalency of the claims are to be embraced within their scope.

The foregoing detailed description has set forth various forms of the systems 100, 500, 1100, 1200 and/or processes 1300 via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted being prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to enable one of ordinary skill in the art to utilize the various forms and with various modifications as are suited to the particular use contemplated. It is intended that the claims submitted herewith define the overall scope.

What is claimed is:

1. A system comprising:
a plurality of storage devices operable to receive compressible fluid from a high-pressure source;
a flow line network extending between and fluidly connecting the plurality of storage devices and the high-pressure source;
a plurality of stoppage valves in fluid communication with the flow line network, the plurality of stoppage valves operable to:
fluidly connect the plurality of storage devices in a series arranged sequentially from a highest-pressure storage device of the plurality of storage devices to a lowest-pressure storage device of the plurality of storage devices;
fluidly disconnect one or more storage devices from the series; and
fluidly connect one or more additional storage devices to the series;
a plurality of flow control valves in fluid communication with the flow line network, the plurality of flow control valves operable to control a flow rate of a portion of compressible fluid received by each storage device; and
a plurality of chillers in thermal communication with the flow line network, the plurality of chillers operable to decrease a temperature of the portion of compressible fluid received by each storage device.

2. The system of claim 1, further comprising a plurality of sensors operable to measure one or more characteristics of the portion of compressible fluid within each storage device.

3. The system of claim 2, wherein one or more stoppage valves of the plurality of stoppage valves are operable to actuate in response to the one or more characteristics of the portion of compressible fluid within one or more storage devices meeting a threshold.

4. The system of claim 2, wherein the one or more characteristics of the portion of compressible fluid within each storage device comprise one or more of:
the temperature of the portion of compressible fluid; or
a pressure of the portion of compressible fluid.

5. The system of claim 1, wherein each storage device is a storage tank array comprising a plurality of storage tanks fluidly connected in parallel between:
a first manifold operable to deliver compressible fluid from the flow line network to each storage tank of the plurality of storage tanks simultaneously; and
a second manifold operable to deliver a portion of compressible fluid from each storage tank of the plurality of storage tanks to the flow line network simultaneously.

6. The system of claim 5, wherein each storage tank of the plurality of storage tanks comprises:
an inlet in fluid communication with the first manifold and disposed at a first end of the storage tank; and
an outlet in fluid communication with the second manifold and disposed at a second end of the storage tank.

7. The system of claim 5, wherein each storage tank of the plurality of storage tanks comprises:
an inlet in fluid communication with the first manifold and disposed at a first end of the storage tank;
an outlet in fluid communication with the second manifold and disposed at the first end of the storage tank; and
a conduit extending, within an interior of the storage tank, from the inlet or the outlet towards a second end of the storage tank.

8. The system of claim 1, wherein the portions of compressible fluid being received by each storage device are transported downstream in the series by pressure differentials between sequentially adjacent storage devices of the series.

9. The system of claim 1, wherein the flow rate of the portion of compressible fluid being received by each storage device decreases after each storage device in the series by the plurality of flow control valves.

10. The system of claim 1, wherein each storage device is operable to couple with a vehicle configured to transport the storage device.

11. The system of claim 10, further comprising a plurality of bays in fluid communication with the flow line network, each bay comprising:
an inlet line operable to fluidly connect an inlet of a storage device to the flow line network; and
an outlet line operable to fluidly connect an outlet of the storage device to the flow line network.

12. A method comprising:
actuating one or more stoppage valves of a plurality of stoppage valves in fluid communication with a flow line network extending between a plurality of storage devices and a high-pressure source to fluidly connect the plurality of storage devices in a series arranged sequentially from a highest-pressure storage device of the plurality of storage devices to a lowest-pressure storage device of the plurality of storage devices;
receiving, by each storage device of the plurality of storage devices, a portion of compressible fluid from upstream in the flow line network such that the portion of compressible fluid received by the highest-pressure storage device is transported from the high-pressure source and the portion of compressible fluid received by the lowest-pressure storage device is transported from a sequentially upstream storage device in the series;
controlling, by a plurality of flow control valves in fluid communication with the flow line network, a flow rate of the portion of compressible fluid being received by each storage device;
decreasing, by a plurality of chillers in thermal communication with the flow line network, a temperature of the portion of compressible fluid being received by each storage device;
actuating one or more stoppage valves to fluidly disconnect the highest-pressure storage device from the series, wherein a storage device previously sequentially downstream of the disconnected highest-pressure storage device becomes the highest-pressure storage device; and
actuating one or more stoppage valves to fluidly connect an additional storage device to the series, wherein the additional storage device comprises a pressure less than the lowest-pressure storage device such that the additional storage device becomes the lowest-pressure storage device.

13. The method of claim 12, further comprising measuring one or more characteristics of the portion of compressible fluid within each storage device with one or more sensors.

14. The method of claim 13, wherein actuating the one or more stoppage valves of the plurality of stoppage valves is based on the one or more characteristics of the portion of compressible fluid within one or more storage devices meeting a threshold.

15. The method of claim 14, wherein the one or more characteristics of the portion of compressible fluid within each storage device comprise one or more of:
the temperature of the portion of compressible fluid; or
a pressure of the portion of compressible fluid.

16. The method of claim 12, wherein each storage device is a storage tank array comprising a plurality of storage tanks fluidly connected in parallel between a first manifold and a second manifold, the method further comprising:
delivering, through the first manifold, compressible fluid from the flow line network to each storage tank of the plurality of storage tanks simultaneously; and
delivering, through the second manifold, a portion of compressible fluid from each storage tank of the plurality of storage tanks to the flow line network simultaneously.

17. The method of claim 12, further comprising transporting the portions of compressible fluid downstream in the series by pressure differentials between sequentially adjacent storage devices of the series.

18. The method of claim 12, wherein controlling the flow rate of the portion of compressible fluid being received by each storage device comprises decreasing the flow rate after each storage device in the series by the plurality of flow control valves.

19. The method of claim 12, wherein each storage device in the series is fluidly connected to a bay of a plurality of bays in fluid communication with the flow line network, each bay comprising an inlet line and an outlet line, the method comprising:
fluidly connecting an inlet of a storage device to the flow line network by the inlet line; and
fluidly connecting an outlet of the storage device to the flow line network by the outlet line.

20. The method of claim 19, further comprising:
transporting the disconnected highest-pressure storage device to another location away from the flow line network; and
transporting the additional storage device to an empty bay of the plurality of bays;
wherein the plurality of bays comprises one or more empty bays.
